(19) United States
(12) Patent Application Publication
(10) Pub. No.: US 2026/0349803 A1
(43) Pub. Date: Nov. 5, 2026

(54) METHOD AND SYSTEM FOR MIGRATION OF ACTIONS BETWEEN SOFTWARE APPLICATIONS

(71) Applicant: Honeywell International Inc., Charlotte, NC (US)

(72) Inventors: Harish Iniyarajan, Chennai (IN); Shravan Tilak, PUNE (IN)

(21) Appl. No.: 19/194,021

(22) Filed: Apr. 30, 2025

(51) Int. Cl. G06F 9/50

(52) U.S. Cl. CPC G06F 9/5027

(57) ABSTRACT

The present disclosure relates to a method and system for migration of actions between software applications, based on identifying a clickable button to be migrated from a first software application to a second software application, and identifying an icon associated with the clickable button, where the icon is stored in a location accessible to the first software application, and the icon includes at least one of an image, an emoji, a graphic symbol, and a text box. A unique name is extracted for icon by the method and system, where the unique name is independent of the location of the icon in the first software application, and details relating to the clickable button and the unique name of the icon are transferred by the method and system, from the first software application to the second software application. Further, the a path in one or more databases accessible to the second software application, is identified for the icon by the method and system based on the unique name of the icon. The identified path of the icon is linked to the clickable button in the second software application by the method and system, and the clickable button is displayed in the second software application by accessing the icon using the linked path.

### TECHNICAL FIELD

The present disclosure relates to a system and method for migrating actions between software applications, and particularly, relates to migration of actions from one software application to another involving generation of unique names for icons associated with the actions.

### BACKGROUND

Different actions are used in a software application for performing well-defined response behavior or functionalities of the software application, where each action can be performed by a clickable button. Each clickable button in a software application may be configured with respect to a specific functionality. A clickable button of a software application is rendered with an icon (or an image), and such an icon is generally indicative of the functionality associated with the clickable button. The icons of clickable buttons are conventionally stored in some location on a server or database accessible to the software application, and location of the icon of each clickable button of the software application are either directly configured to the clickable button or are returned to the clickable button based on performing of some calculation or processing. The location of an icon of a clickable button is generally linked to the clickable button as a file path, and such file paths are generally sensitive, and even a single typographical error may impact an associated icon of a clickable button.

Such a sensitive nature of file paths poses significant challenges while migrating clickable buttons from one software application to another, as the new server may not have the icons of the migrated clickable buttons in the same location, thereby leaving the file paths incorrect and ineffective. The clickable buttons are generally migrated from a first software application to a second software application when transitioning to the second software application, or to implement the functionalities of the first software application in a different processing environment compatible for different devices and/or servers. Existing methods of migrating clickable buttons used in such scenarios involves transferring all the icons of all the clickable buttons to be migrated based on icons'path, and as such path may not be available on the second software application, the existing methods require reconfiguring all the actions to configure a new file of an icon to the corresponding clickable button. In such instances, the new file path of each icon corresponds to a location in a new server of the second application to which the icons are migrated.

Hence, there is a requirement for a mechanism of migrating actions or clickable buttons from one software application to another software application without using file paths.

### SUMMARY OF THE INVENTION

In general, embodiments of the present disclosure herein provide a system and method for migration of actions between software applications. Other implementations will be, or will become, apparent to one with skill in the art upon examination of the following figures and detailed description. It is intended that all such additional implementations be included within this description be within the scope of the disclosure and be protected within the scope of the following claims.

In accordance with an embodiment of the present disclosure, a method for migration of actions between software applications is described. The method comprises identifying a clickable button to be migrated from a first software application to a second software application, and identifying an icon associated with the clickable button, where the icon is stored in a location accessible to the first software application, and the icon includes at least one of an image, an emoji, a graphic symbol, and a text box. The method further comprises extracting a unique name of the icon, where the unique name is independent of the location of the icon in the first software application, and transferring details relating to the clickable button and the unique name of the icon, from the first software application to the second software application. The method also comprises identifying for the icon, a path in one or more databases accessible to the second software application, based on the unique name of the icon, and linking the clickable button with the path of the icon, in the second software application.

In one aspect, the method further comprises rendering the clickable button with the icon on a user interface of the second software application. In another aspect, the method further comprises providing a functionality in the second software application based on the details relating to the clickable button transferred from the first software application. In yet another aspect, the method further comprises uploading a set of icons of the first software application to the one or more databases accessible to the second software application.

In one aspect, the clickable button to be migrated from the first software application to the second software application is identified based on capabilities of the second software application, and the capabilities of the second software application are known before the migration.

In one aspect, the details relating to the clickable button includes functionality data, and the icon associated with the clickable button is identified based on the functionality data associated with the clickable button.

In one aspect, the unique name for the icon is extracted based on processing of the functionality data associated with the clickable button. The path of the icon is identified based on matching of the unique name of the icon to files stored in the one or more databases accessible to the second software application.

In another embodiment of the present invention, an exemplary system for migration of actions between software applications. The system comprises a processor and a memory coupled with the processor, wherein the memory stores program instructions configured to identify a clickable button to be migrated from a first software application to a second software application, and identify an icon associated with the clickable button, where the icon is stored in a location accessible to the first software application, and the icon includes at least one of an image, an emoji, a graphic symbol, and a text box. The program instructions are further configured to extract a unique name of the icon, where the unique name is independent of the location of the icon in the first software application, and transfer details relating to the clickable button and the unique name of the icon, from the first software application to the second software application. The programs instructions are also configured to identify for the icon, a path in one or more databases accessible to the second software application, based on the unique name of the icon, and link the clickable button with the path of the icon, in the second software application.

In yet another embodiment of the present invention, a non-transitory computer-readable storage medium is provided comprising computer program code for execution by one or more processors of an apparatus, the computer program code configured to, when executed by the one or more processors, cause the apparatus identify a clickable button to be migrated from a first software application to a second software application, and identify an icon associated with the clickable button, where the icon is stored in a location accessible to the first software application, and the icon includes at least one of an image, an emoji, a graphic symbol, and a text box. The computer program code is further configured extract a unique name of the icon, where the unique name is independent of the location of the icon in the first software application, and transfer details relating to the clickable button and the unique name of the icon, from the first software application to the second software application. The computer program code is also configured to identify for the icon, a path in one or more databases accessible to the second software application, based on the unique name of the icon, and link the clickable button with the path of the icon, in the second software application.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

The accompanying drawings constitute a part of the description and are used to provide further understanding of the present disclosure. Such accompanying drawings illustrate the embodiments of the present disclosure which are used to describe the principles of the present disclosure. The embodiments are illustrated by way of example and not by way of limitation in the figures of the accompanying drawings in which like references indicate similar elements. It should be noted that references to “an” or “one” embodiment in this disclosure are not necessarily to the same embodiment, and they mean at least one. In the drawings:

FIG. 1 illustrates a system for migrating actions from a first application to a second application, in accordance with an embodiment of the present invention;

FIG. 2 illustrates an exemplary implementation of the proposed system for enabling the creation and run-time operation of a new software application which uses migrated actions, in accordance with an embodiment of the present invention;

FIG. 3 illustrates steps executed by a method for migrating actions from a first application to a second application, in accordance with an embodiment of the present invention;

FIG. 4 illustrates a unique name generation module for generating unique names for icons, in accordance with an embodiment of the present invention;

FIG. 5 illustrates steps executed for generation of unique names for icons, in accordance with an embodiment of the present invention;

FIG. 6 illustrates a linking module for incorporating clickable buttons of an existing software application in a new software application based on unique names of their associated icons, in accordance with an embodiment of the present invention;

FIG. 7 illustrates steps executed for linking of clickable buttons incorporated in a new software application with associated icons, in accordance with an embodiment of the present invention;

FIG. 8 illustrates an exemplary system for migrating actions from different software applications to a new software application, in accordance with an embodiment of the present invention;

FIG. 9 illustrated a module for identification of clickable buttons and associated icons to be migrated from different software applications, in accordance with an embodiment of the present invention;

FIG. 10 illustrates steps executed by a module for identification of clickable buttons and associated icons to be migrated from different software applications, in accordance with an embodiment of the present invention; and

FIG. 11 illustrates an exemplary system for migration of actions from an existing software application to a new software application sharing a common storage resource, in accordance with an embodiment of the present invention.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way that enables one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labelled with the same reference numerals. However, sometimes these elements may be labelled with differing numerals, such as, for example, in cases where such labelling facilitates a clearer description. Additionally, the drawings set forth herein are not necessarily drawn to scale, and in some instances, proportions may have been exaggerated to more clearly depict certain features. Such labelling and drawing practices do not necessarily implicate an underlying substantive purpose. As stated above, the specification is intended to be taken as a whole and interpreted in accordance with the principles of the invention as taught herein and understood to one of ordinary skill in the art.

With respect to the exemplary systems, components and architecture described and illustrated herein, it should also be understood that the embodiments may be embodied by, or employed in, numerous configurations and components, including one or more systems, hardware, software, or firmware configurations or components, or any combination thereof, as understood by one of ordinary skill in the art. Accordingly, while the drawings illustrate exemplary systems including components for one or more of the embodiments contemplated herein, it should be understood that with respect to each embodiment, one or more components may not be present or necessary in the system.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

The present disclosure relates to a method and system for migration of actions between software applications. The proposed method and system involve the migration of actions from a first software application to a second software application, such that a clickable button corresponding to each action is transferred from the first application to the second application based on a unique name assigned to an icon of the clickable buttons, instead of using a path-based migration. The proposed method involves identifying a clickable button to be migrated from a first software application to a second software application, corresponding to an action performed in the first software application. An icon associated with the clickable button is then identified, and a unique name is extracted for the icon. Thereafter, the unique name of the icon of the clickable button is transferred to the second software application along with details relating to the clickable button. The icon of the clickable button is linked to the second software application based on a path of the icon, where the path of the icon with respect to a database among one or more databases accessible to the second software application is identified based on the unique name of the icon.

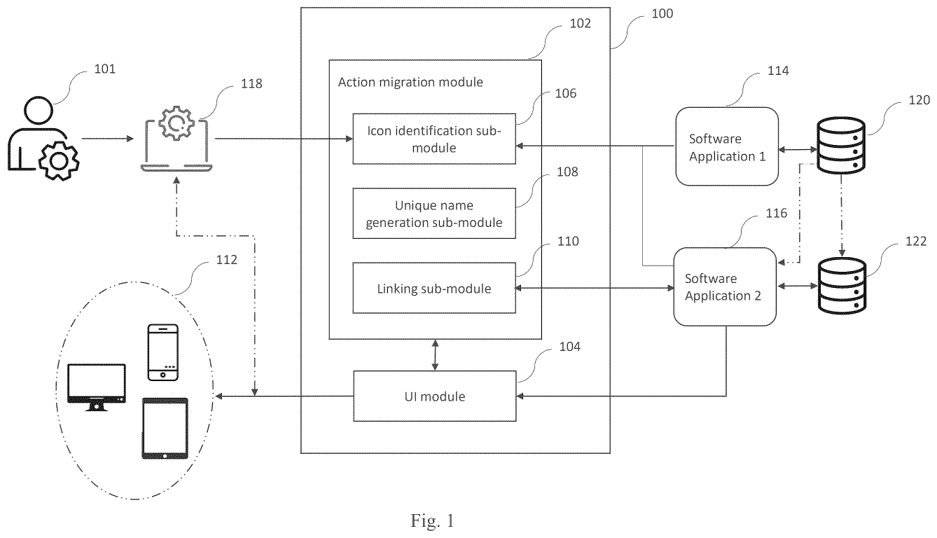

FIG. 1 illustrates a system for migrating actions from a first software application to a second software application, in accordance with an embodiment of the present invention. The system 100 comprises an action migration module 102 and a UI module 104. The action migration module 102 comprises an icon identification sub-module 106, a unique name generation sub-module 108, a linking sub-module 110, and is used for migrating actions from the first software application to the second software application. The UI module 104 may be used for rendering the actions migrated to the second software application in a User Interface (UI) generated at one or more output devices 112-1 to 112-1 (collectively labelled 112).

The migration of actions from the first software application to the second software application using the system 100 involves identification of a first software application 114 from which actions are to be migrated to a second software application 116. The first software application 114 may be indicated to the action migration module 102 of the system 100 by an authorized individual 101. The first software application 114 from which actions are to be migrated is indicated by the authorized individual 101 to the icon identification sub-module 106 of the action migration module 102 by means of an input device 118. In an embodiment, the indication may be retrieved from the authorized individual 101 by means of a UI generated at the input device 118 by the UI module 104 of the system 100, and the indication retrieved by the UI module 104 may thereafter be provided to the icon identification sub-module 106.

The icon identification sub-module 106 of the action migration module 102 may be used for identifying the icons corresponding to the actions to be migrated from the first software application 114 to the second software application 116. Hence, receipt of an indication regarding the first software application 114 from which the actions are to migrated constitutes an initial point of the operation of the icon identification sub-module 106. On determining the first software application 114 based on the received indication, the icon identification sub-module 106 identifies one or more actions to be migrated from the first software application 114 to the second software application 116.

The first software application 114 may have a plurality of different actions, where the different actions are used for performing well-defined response behaviour or functionalities of the first software application 114. The actions may be clickable buttons which may be rendered with icons such an image, emoji, graphic symbol, or text box, where the icons may be used for illustrating or representing the functionality performed on clicking the clickable button, However, the second software application 116 that is to be developed may not require the incorporation of all the functionalities, and thereby clickable buttons, of the first software application 114. Hence, all the clickable buttons corresponding to all the functionalities of the first software application 114 are not to be migrated to the second software application 116. The clickable buttons, and the corresponding icons, to be migrated from the first software application 114 to the second software application 116 are identified by the icon identification sub-module 106 based on determination of the response behaviours or functionalities to be incorporated in the second software application 116.

Such a determination of the functionalities of the first software application 114 to be incorporated in the second software application 116 may be based on an input provided by the authorized user 101 by means of the input device 118 to the icon identification sub-module 106, where such input may be provided via the UI module 104. The input provided may be a specification or listing of the capabilities to be performed or implemented by the second software application 116. In certain embodiments, the icon identification sub-module 106 may be used to identify one or more functionalities of the first software application 114 which may be required to be incorporated in the second software application 116 for enabling the capabilities determined by from the user input.

In another embodiments, the input provided by the authorized user 101 may include a specification of the different functionalities of the first software application 114 to be incorporated into the second software application 116 to enable the capabilities of the second software application 116. In yet another embodiment, the input provided by the authorized user 101 may include a specification of the one or more clickable buttons of the first software application 114 that are to be included in the second software application 116, corresponding to the capabilities that are to be implemented by the second software application 116.

In certain embodiments, the second software application 116 may be configured with details relating to its framework, wherein the details may include information relating to the capabilities of the second software application 116, the functionalities to be incorporated from the first software application 114, and the clickable buttons that are to be rendered in a user interface of the second software application 116 for enabling the capabilities if the second software application 116. In one embodiment, the details relating to the framework of the second software application 116 may be pre-configured, and such configurations may be saved in a second database 120 connected to or associated with the second software application. The pre-configured details may be retrieved by the icon identification sub-module 106 from the second database 122 and used for determining the capabilities to be performed by the second software application 116 and the clickable buttons to be migrated from the first software application 114 for enabling the determined capabilities.

On determination of the capabilities of the second software application 116, and the clickable buttons or actions of the first software application 114 to be migrated to the second software application 116 to enable such capabilities, the icon identification sub-module 106 thereafter identified the icons to be migrated to the second software application 116 for rendering the clickable buttons therein. Hence, an icon is identified corresponding to each clickable button that is to be migrated to the second software application 116. The icon corresponding to each clickable button may be determined by the icon identification sub-module 106 based details relating to the clickable button. Such details relating to each of the clickable buttons of the first software application 114 may be saved in a first database 120 connected to or associated with the first software application 114.

The details of each clickable button may include information relating to the functionality of the first software application 114 with which the clickable button is associated, and information relating to the icon used for rendering the clickable button in the first software application 114. The information relating to the icon may include details regarding the format of the icon file, the file path of the icon file, the size of the icon file etc. In certain embodiments, the icon file may be saved in the first database 120. In other embodiments, the icon file may be stored in any other dataset, repository, or server accessible to the first software application 114. In such embodiments, the file path of the icon file constitutes a path that may be used for accessing the icon file.

Hence, the identification of an icon of each clickable button of the first software application 114 to be migrated to the second software application 116 by the icon identification sub-module 106 also involves determination of the location of the icon or the file path of the icon. In certain embodiments, a clickable button to be migrated to the second software application 116 may have a plurality of icons that are used for rendering the clickable button. In such embodiments, for each clickable button, the icon identification sub-module 106 determines the file path of the one or more associated icons.

The information determined by the icon identification sub-module 106, i.e., details relating to the first software application 114 from which functionalities are to migrated to the second software application 116, details relating to the clickable buttons required for providing such functionalities in the second software application 116, and the details of the icon of each clickable button, may be used by the unique name generation sub-module 108 of the action migration module 102. The unique name generation sub-module 108 generates a unique name for each of the icons corresponding to each of the clickable buttons of the first software application 114 to be migrated to the second software application 116.

Unique names for the icons of the clickable buttons to be migrated to the second software application 116 may be generated by the unique name generation sub-module 108 based on processing of the information received as input from the icon identification sub-module 106. The processing of the information may involve determination of the different icons corresponding to the clickable buttons to be migrated, and determining for each of the icon the associated clickable button and the file path of the icon. The processing of the information may also include determination of different properties of each icon such as the file size of the icon file, and the format of the icon.

The unique name for each of each icon may be generated based on rules defined for such naming. The rules may be pre-defined by one or more individuals such as software developers and engineers associated with the construction of framework of the second software application 116. The rules may be pre-defined by such individuals to ensure conformance with the framework of the second software application 116. The pre-defined rules may be stored in the second database 122 associated with the second software application 116, and may be retrieved by the unique name generation sub-module 108. The pre-defined rules may comprise a general set of rules for the generation of unique names, and different rules specific to generation of unique name of icons based on the different types of icons and the different types of associated clickable buttons.

The unique name generation sub-module 106 takes one icon from the set of icons corresponding to the clickable buttons to be migrated, and for each icon, retrieves applicable rules for the generation of the corresponding unique name from the pre-defined rules. The retrieved rules may thereafter be used by the unique name generation sub-module 106 for the generation of a unique name for the icon. In an embodiment, the unique name generated using the retrieved rules may be based on the file name of the icon in the first database 120 of the first software application 114. The file name of the icon may be determined based on processing of the file path obtained as input from the icon identification sub-module 106.

In another embodiment, the unique name generated for an icon by the unique name generation sub-module 106 may be based on rules relating to the properties of the icon and the associated clickable button such as the format of the icon file, the type of clickable button etc. In an embodiment, the rules retrieved and utilized for generation of a unique name of an icon may include specifications relating to the desired length of the unique name, the desired complexity of interpreting nature of the icon based on the unique name. In certain embodiments, the rules retrieved for generation of unique name of an icon may also involve methods of encrypting the unique name.

The unique names generated for the icons associated with the clickable buttons to be migrated may be saved as a record or an index by the unique name generation sub-module 108. The record or index may comprise, corresponding to each icon, the unique name generated for the icon and the file name of the icon. Such a record, hereafter referred to as icon record, may be saved in the second database 121220 of the second software application 116. In one embodiment, the icon record may also comprise, for each icon, a field containing details regarding the associated clickable button. In another embodiment, the icon record of the unique names generated may also comprise the unique name of each icon, and a reference to the rules used for generating the icon.

The details relating to the clickable buttons to be migrated to the second software application 116, and the unique names generated for each icon associated with the clickable buttons obtained from the unique name generation sub-module 108 may be retrieved and used by the linking sub-module 110 for migrating the clickable buttons and linking the icons to the clickable buttons. The details relating to the clickable buttons may be obtained from information generated by the icon identification sub-module 106, where the information include the functionalities of the first software application 114 to be migrated, the clickable buttons required for providing such functionalities, details relating to clickable button, and the icons associated with the clickable buttons.

The details relating to each clickable button, retrieved by the linking sub-module 110, include the functionality with which the clickable button is associated, the actions implemented by the clickable button, the configurations relating to displaying of the clickable button etc. Migration of the clickable buttons of the first software application 114 to the second software application 116 by the linking sub-module 110 involves transferring of the details relating to the clickable buttons and the unique names of the icons to the second database 122, or a database, repository or server associated with and accessible to the second software application 116.

After the transfer of the details of each clickable button and the unique names of the icon associated with the clickable button, the linking sub-module 110 may be used for incorporating the clickable button in the second software application 116. The incorporation of the clickable buttons into the second software application 116 is performed during the development of the framework of the second software application 116. During the development or creation of the second software application 116, which may be performed based on configuration data stored in a database accessible to the second software application 116, one or more clickable buttons may be required to be incorporated to enable a capability of the second software application 116.

In such an instance, if the one or more clickable buttons are incorporated from the first software application 114, then the details relating to each of the clickable buttons and the unique name of the icon associated with the clickable button is retrieved from the second database 122, or any other storage location within which the details were stored by the linking sub-module 110. The details relating to each of the clickable button is used for incorporating or setting up the clickable buttons in the second software application 116, and the unique name of the icon associated with each clickable button is used for rendering the clickable button in a UI of the second software application 116.

The clickable buttons, incorporated in the second software application 116 based on the details relating to the clickable buttons, may be visually rendered in a UI of the second software application 116 only by linking of the clickable buttons with icon files corresponding to the associated icons. Each clickable button is linked with the icon files based on the file path of the icon file, wherein the file path relates to a path used for accessing the icon file by the second software application 116. The file path for linking an icon to the corresponding clickable button is determined based on the unique name of the icon generated by the unique name identification sub-module 108.

For determining the file path of an icon associated with a clickable button incorporated in the second software application 116, the unique name of the icon is used by the linking sub-module 110 to identify a file name of the icon file. The file name of the icon is retrieved from the icon record stored in the second database 122. The icon record comprises the unique name generated for each icon of the clickable buttons to be transferred to the second software application 116, and the corresponding file name. Hence, for an icon of a clickable button incorporated in the second software application 116, the linking sub-module 110 performs a search of the record based on the unique name of the icon, and retrieves the corresponding entry or field relating to the file name.

On identifying the file name of the icon, the linking sub-module 110 performs a search for the icon file in all the databases, servers, and repositories accessible to the second software application 116 based on the identified file name. All the databases, servers, and repositories accessible to the second software application 116 may include the first database 120 used by the first software application 114 for storing information relating to its clickable buttons, and the icons used for rendering such clickable buttons.

After the identification of the icon file based on the searching performed using the file name, the file path of the location at which the icon file is stored in determined with respect to the second software application 116, i.e., the path from the second software application 116 to the location of the icon file is determined. The determined file path is used for linking the icon file to the clickable button, so as to enable the rendering of the clickable button in a UI of the second software application 116 during the run-time implementation of the second software application 116.

The UI module 104 of the system 100 is used for generating and displaying the UI of the second software application 116 to users, wherein the UI is generated at the output device 112 of a user using the second software application 116. The UI module 104 displays different aspects of the second software application 116 to the user, including the clickable buttons used for implementing capabilities of the second software application 116. The clickable buttons are displayed in the UI of the second software application 116 based on configurations of the clickable buttons, and using icons associated with icons. The clickable buttons may include clickable buttons designed and created specifically for the second software application 116, and one or more clickable buttons migrated from the first software application 114.

The one or more migrated clickable buttons are rendered in the UI of the second software application 116 by the UI module 104 with the corresponding icon, based on the linking of icons files with the corresponding clickable button by the linking sub-module 110 using the file path of icon files. The UI module 104, for each migrated clickable button to be displayed, accesses the corresponding icon file linked to the clickable button from the location indicated by the file path, and renders the same in the UI generated at the output device 112 of a user.

Thus, one or more functionalities are provided in the second software application 116 based on clickable buttons migrated from the first software application 114, and the rendering of such clickable buttons using associated icons in the UI of the second software application 116 generated at the output device 112 may be done based on the details relating to the clickable buttons that were transferred during migration of the clickable buttons. In certain embodiment, such details may include information relating to how the clickable button is to be displayed, the functionalities or actions performed by the second software application 116 on clicking of the buttons etc.

In certain embodiments, the second software application 116 may not have access to the servers, databases and/or repositories used by the first software application 114 for storing the icon files of the clickable buttons. In such embodiments, the icons files associated with the one or more clickable buttons identified by the icon identification sub-module 106 to be necessary for implementing capabilities of the second software application 116 may be transferred to the second database 122 or any other database, server, or repository accessible to the second software application 116. Such a transfer of icons files may be performed by the linking sub-module 110, in addition to the transfer of details of the clickable buttons and the unique names of icons of the clickable buttons. During linking of the clickable buttons with the file paths of the corresponding icons, the searching performed by the linking sub-module 110 may be restricted to the second database 122, or the other database, server, or repository used for storing the icon files. In certain embodiments, a single database may be shared by both the first software application 114 and the second software application 116 for storing configuration data of the clickable buttons, storing of icon files, icon records, details relating to clickable buttons to be migrated and unique names of the associated icons etc.

The method adopted by the proposed system 100 enables the migration of the clickable buttons from one software application to another without causing difficulties arising due to the applications not having the icons stored in the same location. The proposed system 100 also overcomes the drawbacks associated with transferring all the icons, and then reconfiguring the actions or clickable buttons to take corresponding icons from a new path. Thus, the proposed system 100 may be used for enabling the creation of the framework of a new software application that utilizes actions or clickable buttons of an existing software application, and may also be used during run-time operation of the new software application for rendering of the clickable buttons migrated from the existing software application.

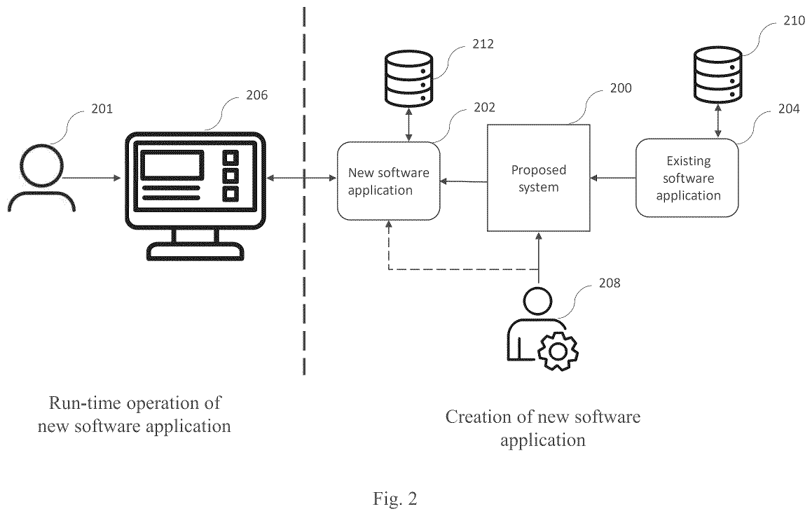

FIG. 2 illustrates an exemplary implementation of the proposed system for enabling the creation and run-time operation of a new software application which uses migrated actions, in accordance with an embodiment of the present invention. The system 200 is enabling the creation of the framework of a new software application 202. Specifically, the system 200 is used for migrating one or more clickable buttons (or actions) from an existing software application 204. In addition to such application or implementation of the system 200 during the creation of the framework of the new software application 202, the system 200 may also be used by the new software application 202 during its run-time operation for displaying the migrated clickable buttons in a UI (User Interface) of the new software application 202. The clickable buttons are displayed in the UI rendered in an I/O device 206 used by a user 201 of the new software application 202.

The system 200 may be used for addressing the requirements of different users or individuals at different stages of development or implementation of the new software application 202. Firstly, the system 200 may be used by an authorized individual 208 for the migration of one or more clickable buttons of the existing software application 204 to the new software application 202, where the migration performed by the system 200 may be based on inputs provided by the authorized individual 208. The authorized individual 208 may be a developer of the new software application 202, or any individual authorized to ensure the migration of one or more clickable buttons of the existing software application 204.

The input provided by the authorized individual 208 may be based on the functionalities of the existing software application 204 that the authorized individual wishes to adopt or incorporate in the new software application 202, or is required to be incorporated in order to enable one or more capabilities of the new software application 202. In one embodiment, the input provided by the authorized individual 208 may be a specification of the one or more clickable buttons of the existing software application 204 that is to be incorporated in the new software application 202. The system 200 identifies the icons associated with the specified clickable buttons, generated a unique name for each of the icons, and transfers the unique names and details of the identified clickable buttons to the new software application. Herein, the icons are identified by the system 200 within at least a first database 210 associated with the existing software application 204, and the unique names and details of the identified clickable buttons are transferred to a second database 212 associated with the new software application 202.

In another embodiment, the input provided by the authorized individual may be a specification of the one or more functionalities of the existing software application 204 that is to be implemented by the new software application 202. In such an embodiment, the system 200 may identify the clickable buttons corresponding to the specified functionalities, and migrate the identified clickable buttons by transferring the details relating to the clickable buttons and the unique names generated for each of the icons associated with the identified clickable buttons. In such an embodiment, the clickable buttons associated with the specified functionalities may be identified based on data relating to configuration of the existing software application 204, which may be stored in the first database 210 or any other database configured to the existing software application 204. The data relating to configuration of the existing software application 204 may include the configurations relating to each of the functionalities provided by the existing software application 204, which may include configurations relating to the clickable buttons used for providing the functionalities, and/or the configurations relating to each of the clickable buttons used in the existing software application 204.

The details of the clickable buttons, and the unique names of the icons associated with the clickable buttons, transferred to the second database 212 by the system 200 based on inputs received from the authorized user 208, may be used during the creation of framework of the new software application 202. Specifically, the configuration of one or more functionalities or capabilities of the new software application 202, may require the incorporation of clickable buttons migrated from the existing software application 204. In such cases, the details of the clickable buttons and the unique names of the icons associated with the clickable buttons are used by the system 200 for linking the clickable buttons migrated to the new software application 202 with the corresponding icon file, based on the file path of the icon file. The file path for each of the icons are determined by the system 200, and linked to the clickable buttons.

In certain cases, a developer of the new software application 202 may specify which of the migrated clickable buttons are to be used for providing a certain functionality of the new software application 202 to the system 200 as an input, and the specified migrated clickable buttons may be linked with their associated icons'file paths, which may thereafter be used during run-time operation of the new software application 202 for rendering the clickable buttons. In such cases the developer may be the authorized individual 208, or a separate individual. In certain embodiments, the details relating to each clickable button transferred to the second database 212 by the system 200 may be used by the developer for configuring the operations and rendering of the clickable button in the new software application 202.

On completion of the creation of the framework of the new software application 202, which includes the configuring of the different clickable buttons corresponding to the different functionalities and capabilities of the new software application 202, the new software application 202 may be provided to different users. The run-time operation of the new software application 202 during implementation by the user 201 may involve the need for displaying one or more of the migrated clickable buttons in the UI of the new software application 202 rendered in the I/O device 206 of the user 201. The system 200 may be used by the new software application 202 for accessing the icon files corresponding to each of the migrated clickable buttons, wherein the icons files are retrieved based on the file path linked to each clickable button.

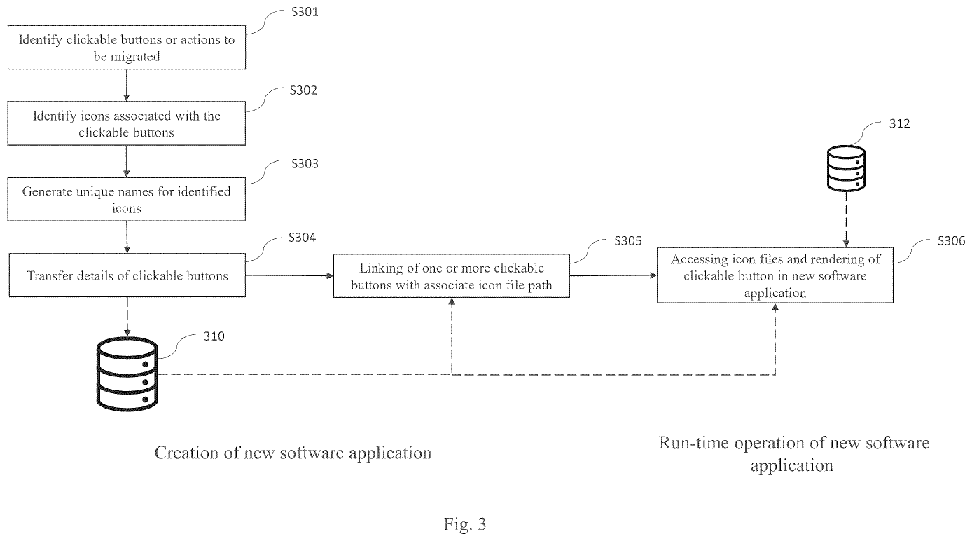

FIG. 3 illustrates steps executed by a method for migrating actions from a first application to a second application, in accordance with an embodiment of the present invention. Step S301 involves the identification of clickable buttons or actions to be migrated from a first software application to a second software application. The identification of the clickable buttons or actions to be migrated may be performed based on an input obtained from an authorized individual designated to perform the migration of clickable buttons from the first software application to the second software application. In certain embodiments, the input provided by the user may comprises a specification of the clickable buttons to be migrated, and a specification of the first software application from which the clickable buttons are to be migrated.

In one embodiment, the input provided by the user may be a direct specification or listing of the clickable buttons that are to be migrated to the second software application. In one embodiment, the input obtained from the authorized individual may be an indication of the functionalities or capabilities of the first software application that is to be incorporated in the second software application. In such as instance, the functionalities or capabilities specified by the authorized individual may be used for determining the clickable buttons that are used in the first software application for providing such functionalities or capabilities.

The identified clickable buttons are used for the identification of the icons associated with the clickable buttons in step S302. Step S302 involves identifying the icons used for rendering or displaying the identified clickable buttons, wherein the icons are identified based on details relating to the identified clickable buttons obtained from the configuration data of the first software application. Specifically, the configuration data relating to each clickable button of the first software application, which includes the icons used for displaying the clickable button, comprised in the configuration data of the first software application, may be used for identifying the icon associated with each identified clickable button. The configuration data of first software application is accessed from a database on the first software application used for storing such data, during the identification performed in step S302.

Step S303 involves generating a unique name for each of the icons identified in step S302. The unique name may be generated for each icon based on a set of rules applicable to the icon, where in the set of rules applicable to the icon are determined from rules pre-configured by developers of the second software application or rules provided by an authorized individual for the generating unique names for the identified icons. The rules pre-configured by the developers may be based on framework requirements of the second software application, or to ensure uniformity with naming conventions used for other files and resources used by the second software application, and to ensure conformity with the framework of the second software application.

The rules applicable for generation of a unique name for an icon may be determined from the set of available rules based on the properties of the icon such as the format of the icon file, the name of the icon file etc. The determined applicable rules may comprise general rules relating to generating a unique name, such as rules relating to use of special characters, rules relating to length of the unique name, rules relating to level of similarity with icon file name etc. The determined applicable rules may also comprise specific rules dependent on the properties of the icons, such as the format of the icon file.

The determined applicable rules may be used for generating a unique name for each of the identified icons. Step S303 also involves the creation of a record of the unique names generated for the identified icons, and such a record may also comprise the corresponding icon file name. In certain embodiments, the records may also contain for each unique name, associated clickable button, and file location of the corresponding icon file.

Step S304 involves transferring of details of the identified clickable buttons and the unique names of the icons to a database 310 associated with the second software application. The details of each identified clickable buttons include the functionality with which the clickable button is associated, the configurations relating to the displaying the clickable button. The unique names of the icons may be transferred as a list, or may be saved along with the details of corresponding identified clickable icons.

Steps S301 to S304 are executed prior to the creation of the second software application, or during the creation of the second software application. During the creation of the second software application by developers, the clickable buttons identified for migration from the first software application is incorporated into the framework of the second software application. The integration of each identified clickable button may be with respect to a corresponding functionality or capability of the second software application, and such integration or incorporation may be performed in step S305.

The integration of each identified clickable button is performed based on the details of the identified clickable button, where such details may be obtained from the database 310. The details relating to the each identified clickable button, especially configuration details relating to displaying of the clickable button, may be used for incorporating the identified clickable button in the framework of the second software application. Specifically, a functionality to be provided by an identified clickable button in the second software application may be implemented by configuring the clickable button using the configurations details obtained from the database 310.

For complete migration and incorporation of each identified clickable button in the second software application, the identified clickable button incorporated in the second software application are linked with the file path of the corresponding icon. Step S305 involves the determination of the file path of each of the icons corresponding to the identified clickable buttons based on the unique names of the icons. The unique name of each icon is retrieved from the database 310, and for each icon, the unique name is used for identifying the corresponding icon file name by accessing the record generated in step S304. The record may be stored in the database 310, or in any other database, server, or repository used during generation of the record.

For each unique name, the corresponding icon file name determined from the record is used for locating the icon file. The icon file is located by performing a name-based search in all the databases and repositories of the first software application accessible to the second software application or a system used for implementing the proposed method. The location of icon file with respect to the second software application is used for determining the file path of the icon file, and the determined file path is linked to the corresponding identified clickable button in the second software application. Step S305 is performed during the creation of the second software application to enable rendering of clickable buttons used for providing certain functionalities or capabilities of the second software application.

After the second software application has been created, it may be used by one or more users for accessing one or more functionalities or capabilities it offers. During such run-time operation of the second software application, clickable buttons created for the second software application and the migrated clickable buttons are rendered in the UI of the second software application created at I/O devices of its users. The clickable buttons created for the second software application are rendered based on accessing corresponding configuration data of the clickable buttons and associated icons from a second database 312. The rendering of the migrated clickable buttons is performed based on accessing of the corresponding icon files using the file path linked to the clickable button, and such accessing of icon files and rendering of the migrated clickable buttons using the accessed icon files is performed in step S306.

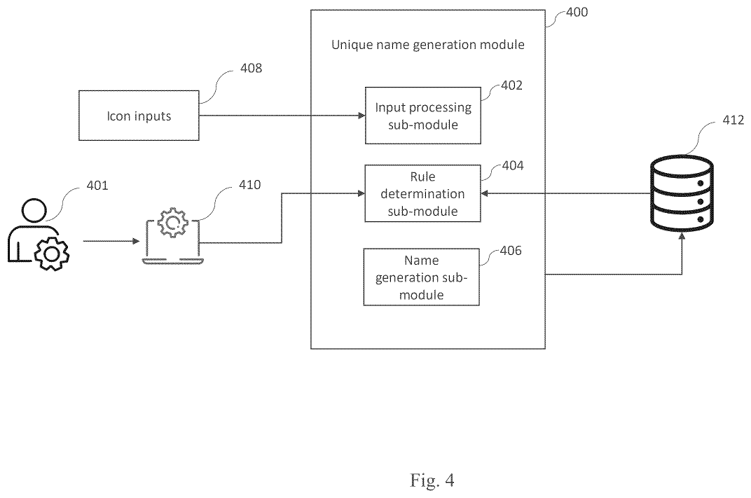

In some embodiments of the present invention, different operations or steps performed in the proposed method may be executed by different disconnected modules, collectively providing the same output. FIG. 4 illustrates a unique name generation module for generating unique names for icons, in accordance with an embodiment of the present invention. The unique names for icons associated with clickable buttons may be generated by a unique name generation module 400 based on inputs relating to the icons for which unique names are to be generated. The unique names are generated by an input processing sub-module 402, a rule determination sub-module 404, and a name generation sub-module 406 of the unique icon name generation module 400. The unique name generation module 400 may be used with respect to icons to be migrated from an existing software application to a new software application.

In one embodiment, the unique name generation module 400 may be used for generating unique names of icons for a new software application where the icons are provided by one or more developers of a new software application, independent of any existing software application. In such an embodiment, different developers may require incorporation of different icons associated with clickable buttons for executing different functionalities of the new software application, where the different icons may be stored in different sources with varying naming conventions. Hence, prior to incorporation of the clickable buttons using the different icons, unique names may be required to be provided to the different icons to ensure uniformity and ease of configuration of the clickable buttons in the new software application.

The inputs relating to the icons based on which the unique names are generated by the unique name generation module 400 may be icon inputs 408, inputs provided by an authorized individual 401, or both. The icon inputs 408 is a set of information relating to the icons for which unique names are to be generated, and such information may include a list of the icons, a list of clickable buttons corresponding to the icons and information relating to the clickable buttons, file names and/or file paths of the icon files, and a list of the different functionalities for which the clickable buttons associated with the icons are used.

The icon inputs 408 may be created by a module associated with the migration of clickable buttons from an existing software application to a new software application, and may comprise information relating to the clickable buttons and the associated icons that are to be migrated to the new software application. In embodiments where the unique name generation module 400 is used for the generation of unique names of icons provided by one or more developers, the icon inputs 408 may be pre-configured by the developers based on the functionalities of the new software application.

In an instance where the inputs are provided by an authorized user 401, the inputs may be provided by an input device 410 comprise a specification of the icons for which unique names are to be generated, a specification of the clickable buttons associated with the icons, and the file names of the icons for which unique names are to be generated. The inputs may be provided by the authorized user 401 in instances where dynamic configuration of the unique name generation module 400 is required, and supports application of the unique name generation module 400 for different use case scenarios.

The inputs, provided by one or both of the icon inputs 408 or the authorized individual 401, may be used by the input processing sub-module 402 of the unique name generation module 400 for identifying the icons for which unique names are to be generated, and obtaining information relating to the icons. The inputs provided to the unique name generation module 400 may contain different types of information relating to the icons for which unique names are to be generated, and the clickable buttons and functionalities associated with each of the icons. From such information, data relevant to generation of a unique name for each of the icons is obtained by the input processing sub-module 402, where such data may include file name of the icon, format of the icon, file size of the icon etc. Herein, format of the icon may be text, image, graphics interchange format (GIF) etc.

The data obtained for each icon by the processing of the inputs by the input processing sub-module 402 is thereafter used by the rule determination sub-module 404 for determining the different rules for name generation that may be used for creating a unique name for each icon. The rules applicable for the generation of a unique name for an icon may vary based on the data obtained for each icon. For instance, a different naming convention may be used for assigning names to icon having text format, as compared to the naming convention used for an icon of image format.

The rules to be applied for each icon may be retrieved from one or more sources.

The sources of rules for generation of unique names may include a database 412 of the new application, which may be used for storing of rules for naming of icons, wherein the rules may be configured by a developer of the new software application in order to ensure conformity with the naming convention used for other files and resources of the new software application. Such rules may be preconfigured to the database based on the required framework of the new software application.

Another source of rules used for the generation of unique names for icons may be inputs provided by the authorized user 401, wherein the inputs may contain specific instructions for naming of icons based on the software application for which the icons are to be used. The set of rules obtained from such sources may be accessed by the rule determination sub-module 404, and may contain a general set of rules relating to the naming of icons, a specific set of rules which may vary based on the icon for which name is to be generated.

For each icon to be named, the rule determination sub-module 404 determines the applicable rules for the icon from the set of accessible to the rule determination sub-module 404. The determination of the applicable rules for generating the unique name of the icon is performed by the rule determination sub-module 404 based on parameters associated with the icon such as format of the icon, file size of the icon file, and name of the icon file, which is obtained from the data generated by the input processing sub-module 402 corresponding to each of the icons.

The applicable rules corresponding to such parameters of the icon is determined by the rule determination sub-module 404. In an embodiment, the rules configured to the database 410 by developers of the new software application may also include directions to the specific rules which are to be applied based on the different parameters associated with each icon. The applicable rules determined by the rule determination sub-module 404 may include general rules for generation of unique names, and specific rules depending on the parameters of the icon. For instance, in certain embodiments, the general rules may include rules relating to the desired length of the unique name, rules relating to use of special characters and numerals within the unique name, and rules relating to ensuring uniqueness of the assigned names. In some embodiments, the rules may also comprise instructions or configurations relating to encryption of the unique name, which is to be performed during the generation of the unique name for each icon.

Further, in certain embodiment, the specific rules may include rules for naming based on the format of the icon, i.e., whether to include inference regarding the format of the icon within the unique name of the icon. The specific rules in such embodiments may also include rules relating to the desired level of similarity of the unique name to be generated with the file name of the icon. Additionally, the clickable button for which the icon is used, or the functionality associated with the icon, obtained from the data generated for each icon by the input processing sub-module 402, may be referenced or used for generating the unique name of the icon. In such instances, the specific rules may also include rules relating to the desired level of referencing of the clickable button or the functionality that may be provided by the icon.

Hence, such general rules and specific rules applicable to each icon may be identified by the rule determination sub-module 404. The determined rules may be used by the name generation sub-module 406 for generating the unique name of each icon. The unique name of each icon may be generated by the name generation sub-module 406 based on the implementation of the determined rules. In certain embodiments, an AI (Artificial Intelligence) or ML (Machine Learning) models may be used by the name generation sub-module 406 for generating the unique names for icons, where such AI or ML models may be trained based on the different types of general and specific rules used for the naming of icons, and data relating to icons. Such trained AI or ML models may be used for generating a unique name of an icon, based on the determined rules for the icon and data relating to the icon provided as inputs to the AI or ML models. Specifically, NLP models may be used for the generation of unique names of each icon based on the determined rule and the data relating to the icon.

The unique name generated by the name generation sub-module 408 for each icon may thereafter be saved in an icon record by the unique name generation module 400 in the database 412 associated with the new software application. The icon record generated by the unique name generation module 400 may be an index comprising the unique name generated for each icon, and the file name of the icon. In certain embodiments, the icon record may also comprise additional details such as the clickable button associated with the unique name, the file path of the icon corresponding to the unique name etc.

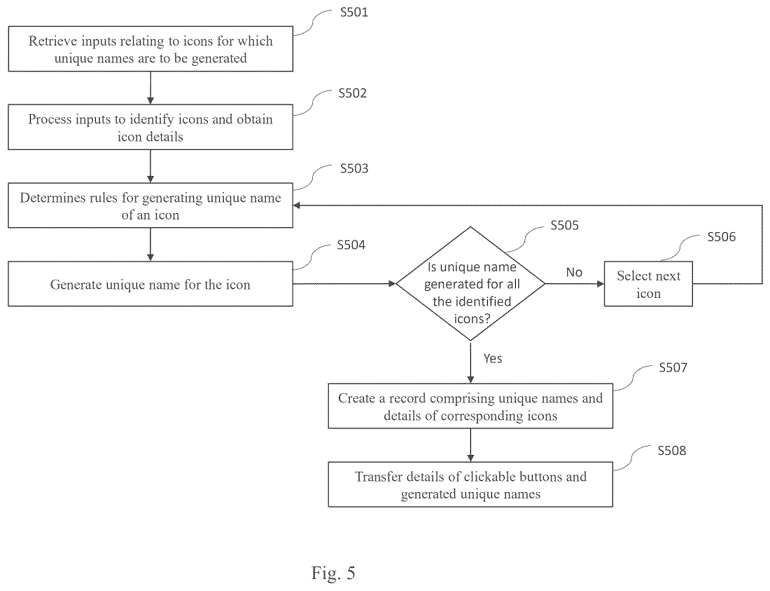

FIG. 5 illustrates steps executed for generation of unique names for icons, in accordance with an embodiment of the present invention. Step S501 involves retrieving of inputs from an authorized user or a module associated with migration of clickable buttons between an existing software application and a new software application. The inputs may be comprised of a set of information relating to the icons for which unique names are to be generated, and such information may include a list of such icons, specification and details of clickable buttons associated with the icons, file names and/or file paths of the icon files etc. The icons for which unique names are to be generated are icons selected for migration from an existing software application to the new software application. In certain embodiments, the icons may be provided by developers of the new software application, independent of any existing software application.

Step S502 involves processing of the inputs retrieved in step S501, and for obtaining information relating to the icons. The retrieved inputs may comprise different types of information relating to the icons for which unique names are to be generated, and the clickable buttons and functionalities associated with each of the icons. From such information, the set of icons for which unique names are to be generated in identified. Additionally, data relevant for generation of a unique name for an icon, such as file name of the icon, format of the icon, file size of the icon etc is also determined from the information comprised in the retrieved inputs.

Step S503 involves identification of rules applicable for generating a unique name for an icon from the identified set of icons. The applicable rules are identified from rules configured by developers or an authorized individual for generating unique icon names for icons to be migrated to the new software application. The rules may be pre-configured, or may be configured based on the icons to be migrated. The applicable rules for an icon are determined from the configured rules based on properties of the icon. The applicable rules determined and retrieved for an application in step S503 may include a general set of rules, and specific rules dependent on the properties of the icon.

Step S504 involves the implementation of the applicable rules for the icon retrieved in step S503, and such implementation is performed to obtain the unique name of the icon. In certain embodiments, the unique name of the icon may be generated by AI or ML models trained on rules relating to generation of unique names of icons, and the unique name of the icon may be generated based on providing of the applicable rules as inputs to the AI or ML model.

Step S505 involves confirming if unique names have been generated for all icons identified in step S502. If not, a next icon from the remaining icons is selected at step S506, and steps S503 and S504 are executed for the next icon. If yes, an icon record comprising the generated unique names and the corresponding icon file name is generated and saved in a database accessible to the new software application at step S507. Further, the details of the clickable buttons to be migrated to the new software application, which comprises data including configurations relating to the display of the clickable buttons, and the unique names generated are transferred to a database accessible to the new software application at step S508.

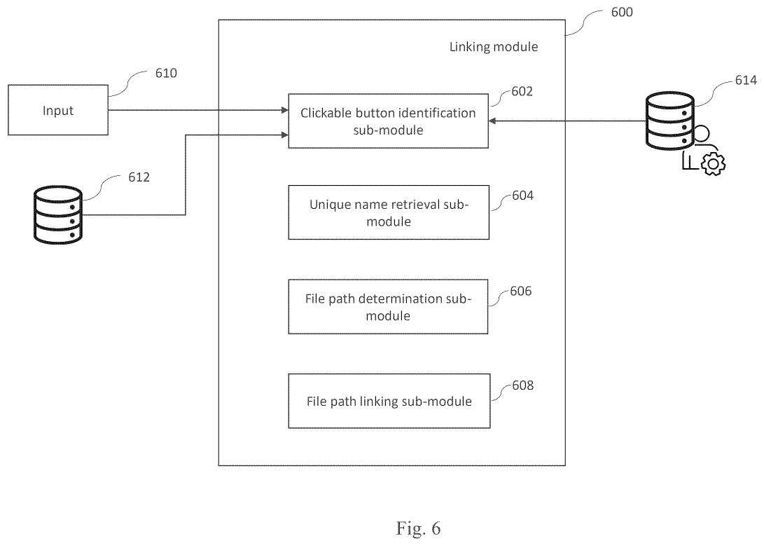

FIG. 6 illustrates a linking module for incorporating clickable buttons of an existing software application in a new software application based on unique names of their associated icons, in accordance with an embodiment of the present invention. The linking module 600 is used for incorporating one or more clickable buttons selected from the various clickable buttons of an existing software application for migration to the new software application. The one or more clickable buttons are selected for enabling one or more intended functionalities or capabilities of the new software application.

The linking module 600 is used during the creation stage of the new software application, for configuring the clickable buttons selected from the existing software application within the new software application. Hence the configuring of the selected clickable buttons within the new software application constitute an aspect of the construction of the framework of the new software application. The incorporation of the selected clickable buttons within the new software applications is performed using a clickable button identification sub-module 602, a unique name retrieval sub-module 604, a file path determination sub-module 606, and a file path linking sub-module 608.

Information relating to the selected clickable buttons is retrieved as input 610 by the clickable button identification sub-module 602. The input 610 may be retrieved from a first module associated with migration of clickable buttons from a first software application to a second software application, wherein the first module may be used for identifying clickable buttons of the first software application to be migrated to the second software application. Hence the input 610 comprises at least a list of clickable buttons of the existing software application selected for migration to the new software application. In one embodiment, the first module may store the clickable buttons to be migrated in a database 612. Hence, for such an embodiment, the selected clickable buttons may be retrieved by the clickable button identification sub-module 602 from the database 612.

Of the clickable buttons obtained from the input 610 (or the database 612), one or more clickable buttons may be associated with a functionality of the new software application. Hence, the clickable button identification sub-module 602 identifies, for each functionality of the new software application, one or more clickable buttons necessary for enabling the functionality. The one or more clickable buttons may be identified based on the configuration of the new software application performed by its developers, wherein such configurations indicate or specify the clickable buttons associated with each functionality. The configuration of each functionality may be obtained from a database used by developers for storing configuration data of the new software application, hereafter referred to as configuration database 614.

In an embodiment where the input 610 or database 612 comprises details relating to the clickable buttons including information relating to functionality associated with the clickable buttons, the identification of the one or more clickable buttons necessary for enabling a functionality may be performed by the clickable button identification sub-module 602 based on processing of such details. Based on processing of the details relating to each of the clickable button retrieved from the input 610 or the database 612, the clickable button identification sub-module 602 may be able to identify the one or more clickable buttons whose functionalities matches the functionality of the new software application. Hence, the one or more clickable buttons required for each functionality of the new software application is identified by the clickable button identification sub-module 602.

For each clickable button identified by the clickable button identification sub-module for a functionality of the new software application, the unique name retrieval sub-module 604 retrieves the unique name of the icon associated with clickable button. The unique name may be generated by the first module, or any other module used for generation of unique names for icons associated with clickable buttons to be migrated to the new software application. The unique names of the icons may be retrieved from the database 610, or any other database used by any of the above-mentioned modules for storing of the unique names of the icons along with details of its associate clickable button. In addition to the unique names of the icons, an icon record created by either of the above-mentioned modules, comprising the unique names and corresponding icon file names, is also retrieved by the unique name retrieval sub-module 604.

The unique name of the icon associated with each clickable button of a functionality may be used by the file path determination sub-module 606 for retrieving a file path of the icon. The unique name of the icon is used for identifying the corresponding icon file name from the icon record, and the one or more databases used by the existing software application accessible to the linking module and the new software application are searched by the file path retrieval sub-module 606 based on the icon file name for identifying the location of the icon file. On identification of the corresponding icon file, the file path of the icon file with respect to the new software application is determined by the file path determination sub-module 606.

The file path determined for an icon associated with a clickable button of a functionality is then linked to the clickable button within the new software application by the file path linking sub-module 608, and such a linking is performed to enable the rendering of the functionality using the clickable button. Herein, the clickable button is configured based on configurations of the clickable button obtained from the details retrieved by the clickable button identification sub-module 602. During run-time operation of the new software application, a clickable button is displayed based on configurations of the clickable button and by accessing of the icon file using the linked file path.

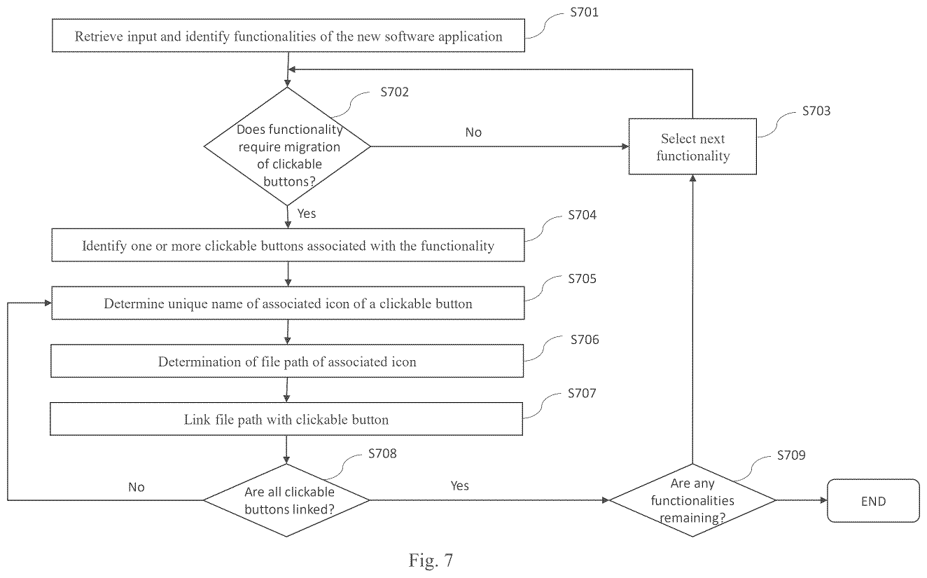

FIG. 7 illustrates steps executed for linking of clickable buttons incorporated in a new software application with associated icons, in accordance with an embodiment of the present invention. Step S701 involves identifying the different functionalities of the new software application that is being developed or created. Step S701 also involves retrieving as input from a module information relating to a set of clickable buttons to be migrated from an existing software application to the new software application, wherein the module is used for identifying and transferring clickable buttons to be migrated from the existing software application to the new software application.

Step S702 involves selection of a functionality, and checking if the implementation of the functionality in the new software application requires the migration of one or more clickable buttons from the set of clickable buttons. If migration is not required, then a next functionality to be implemented is selected at step S703. If migration of one or more clickable buttons from the existing software application is required, then step S704 involving identification of the one or more clickable buttons required for the functionality is performed. The identification may be performed based on the configuration of the functionality, which may be accessible from a database used by developers of the new software application to store configurations of the different functionalities of the new software application. The one or more clickable buttons from the set of clickable buttons identified based on the configuration of the functionality are hence required to be incorporated in the new software application.

Step S705 involves identifying the unique name of the associated icon for each clickable button of the one or more clickable buttons to be incorporated. The unique name of the associated icon may be identified from the information relating to the clickable buttons retrieved at step S701. Step S706 involves identifying the file name of the associated icon from an icon record comprising unique names of icons, wherein the icon record is generated by a module used for generation of unique names of icons to be migrated to the new software application. The icon record is retrieved from the database at step S706, and the entry of the icon record corresponding to the unique name of the associated icon is used for determining the file name of the icon.

S706 further involves a file name-based search in the different databases used by the existing software application which may be accessible to a system used for implementing the proposed steps and the new software application. On locating the icon file, the file path of the icon file with respect to the new software application is determined at step S706. Step S707 involves the incorporation of the clickable buttons based on configuration information of the clickable button retrieved at step S701 to enable the selected functionality. The incorporated clickable button is then linked with the file path of the associated icon, which may be accessed during run-time of the new software application using the file path for rendering the clickable button.

Step S708 involves checking if all the clickable buttons identified for the functionality, from the set of clickable buttons to be migrated, are linked to their associated icons. If there are clickable buttons left to be linked, steps S705 to S707 are executed for the next clickable button. Alternatively, if all clickable buttons have been linked with file path of the associated icons, step S709 involving confirmation if any functionalities are pending is performed. If there are any functionalities still pending to be configured, the next functionality is selected, and the steps are repeated again with respect to the next functionality.

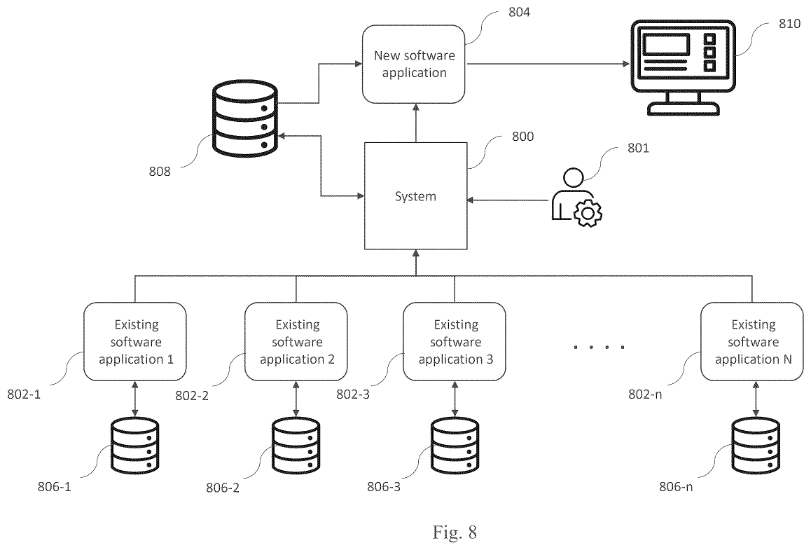

In certain embodiments, a new software application may require the incorporation of actions or clickable buttons corresponding to functionalities offered by different software applications. In such embodiments, the actions or clickable buttons from different software applications may be required to be migrated to the new software application. FIG. 8 illustrates an exemplary system for migrating actions from different software applications to a new software application, in accordance with an embodiment of the present invention. The system 800 may be used to migrate actions or clickable buttons from one or more existing software applications 802-1 to 802-n (collectively labelled 802) to a new software application 804. The clickable buttons to be migration from each of the existing software applications 802 is configured to the system 800 as input from an authorized individual 801.

The input provided by the authorized individual may specify, corresponding to each of the existing software applications 802, the one or more clickable buttons to be migrated. On receipt of such an input, the system 800 identifies, for each of the existing software applications 802, the clickable buttons are specified by the authorized individual 801 and the icons associated with the clickable buttons. The associated icons of the existing software applications 802 is stored in databases 806-1 to 806-n (collectively labelled 806) of the existing software applications 802. On identification of the associated icons stored in the databases 806, the system 800 generates, for each of the existing software applications, a unique name for each icon associated with the specified clickable buttons.

The unique names may be generated by the system 800 based on rules pre-configured by developers of the new software application, or based on rules configured to the system 800 by the authorized individual 801. Based on the configured rules, the system 800 generated a unique name for each icon associated with the specified clickable buttons, for each of the existing software applications 802. After generation of the unique name, the system 800 also generates a record comprising unique names of all the icons, the file name of the icon, and the existing software application from which the icon was obtained, and the generated record may be saved in a new database 808 of the new software application 804.

The unique names of the icons, and the details relating to the configuration of specified clickable buttons corresponding to each of the existing software applications 802 may be transferred to the new software application 804, i.e., the new database 808 or any other storage resource used for the creation and development of the new software application 804. During the creation of the framework of the new software application 804 by its developers, the unique names of the icons and details relating to the configuration of clickable buttons, corresponding to the existing software application 802, may be used for the configuring of the clickable buttons within the framework of the new software application 804.

Specifically, during the construction of a functionality of the new software application 804, one or more clickable buttons from the existing software applications 802 may be required to be incorporated for enabling the functionality. In such instance, the details of configuration relating to the one or more clickable buttons are retrieved from the new database 808, and the clickable buttons are incorporated in the framework of the new software application 804 for enabling the functionality. After configuring of the one or more clickable buttons, the unique names of the icons associated with the one or more clickable buttons are retrieved from the new database 808. For each unique name, a corresponding icon file name is identified from the record accessed from the new database 808, and the location of the icon file is identified based on searching of databases of the respective existing software application.

On locating the icon file, a path file is determined by the system 800 with respect to the new software application 804, and the determined file path is linked with the corresponding clickable button configured in the new software application 804. Such configuring of clickable buttons, and linking of the path file of the associated icons with the corresponding clickable buttons is performed for all functionalities required to be provided by the new software application 804. During run-time operation of the new software application 804, the clickable buttons are rendered in the UI of the new software application 804 generated at an I/O device 810 based on accessing of the corresponding icon files using the file paths linked to the clickable buttons.

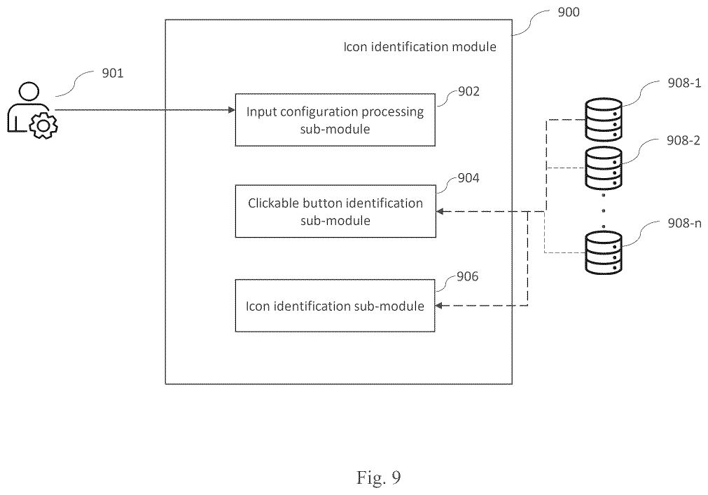

FIG. 9 illustrated a module for identification of clickable buttons and associated icons to be migrated from different software applications, in accordance with an embodiment of the present invention. An icon identification module 900 is used for identifying the clickable buttons and associated icons to be migrated to a new software application, and such identification is performed using an input configuration processing sub-module 902, a clickable button identification sub-module 904, and an icon identification sub-module 906. The icon identification module 900 is used for migrating clickable buttons and icons from one or more existing software applications. Hence, a determination of the clickable buttons and icons to be migrated from each existing software application is to be achieved, which may be obtained processing of input configurations provided by an authorized individual 901.

The authorized individual 901 may be a developer or any other individual associated with the creation of the new software application. The input configurations provided by the authorized individual 901 may be based on the specific functionalities required to be implemented by the new software application, and the specific buttons that may be used in one or more existing software applications which van be incorporated in the new software application for enabling the specific functionalities of the new software applications. The input configurations may comprise specification of the one or more existing software applications from which buttons are to be migrated, and a specification of the clickable buttons required from each of those software applications.

The input configurations provided by the authorized user 901 may be retrieved by the input configuration processing sub-module 902 of the icon identification module 900. The input configuration processing sub-module 902 is used for processing the input configurations to obtain the information relating to nature or properties of clickable buttons that may be required corresponding to a functionality disclosed therein. In certain embodiments, the input configurations may merely be a listing of the functionalities required in the new software applications. The input configuration processing sub-module 902 may be used for processing of such inputs for identifying the existing software applications providing such functionalities.

The information obtained based on the processing of the input configurations by the input configuration processing sub-module 902 such as the possible existing software applications to be accessed for identifying required clickable buttons, or the nature or properties of the clickable buttons that may be required. Such information may be used by the clickable buttons identification sub-module 904 for identifying the specific clickable buttons required corresponding to the input of the authorized individual.

In embodiments where the specific existing software application and the required clickable buttons are provided as input, the clickable buttons identification sub-module 904 may be used for retrieving information of the clickable buttons from a database of the specific existing software application. In embodiments where the specification relating to the required buttons are descriptive, the specification may be processed by the clickable buttons identification sub-module 904 for identifying the specific clickable button that matches such description.

In embodiments where the clickable button may be specified without specifying the existing software application from which it is to be obtained, the clickable buttons identification sub-module 904 may perform searching within databases 908-1 to 908-n (collectively labelled 908) of all the existing software applications for identifying the appropriate clickable button. In such embodiments, the possible existing software applications to be accessed for identifying required clickable buttons, obtained based on processing of the input configurations by the input configuration processing sub-module 902 may be used for narrowing the scope of the search performed by the clickable buttons identification sub-module 904.

On identification of the clickable buttons required corresponding to the input configurations, the icons associated with the identified clickable button are identified using the icon identification sub-module 906. The identification of the associated icons is performed using the details relating to configuration of each clickable button, which may be retrieved from the corresponding database 908. The details relating to configuration of clickable buttons include information relating to the one or more icons used for displaying the clickable buttons in the corresponding software application. Hence, the associated icons are identified by the icon identification sub-module 906 based on accessing of the databases 908 within which the details of configuration of the clickable buttons are stored.

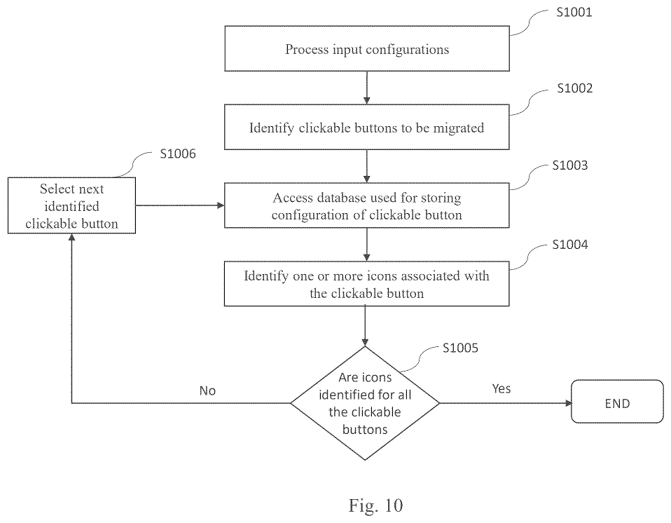

FIG. 10 illustrates steps executed by a module for identification of clickable buttons and associated icons to be migrated from different software applications, in accordance with an embodiment of the present invention. The clickable buttons and associated icons may be identified for migration from one or more existing software applications, based on an input configuration provided by an authorized individual, who may be a developer or any other individual associated with the creation of the new software application.

The input provided by the authorized user may be processed at step S1001, and such processing may be performed to obtain information relating to the different functionalities corresponding to which clickable buttons are to be identified, the different existing software applications that may be accessed for identifying the clickable buttons etc. Such information may be used at step S1002 for identifying the one or more clickable buttons required by the authorized individual. The one or more clickable buttons may be identified based on specific inputs provided by the authorized individual, or based on searches performed in databases of different existing software applications for finding a matching clickable button.

For each clickable button identified at step S1002, the database of the software application to which the clickable button belongs is accessed in step S1003, and the details relating to the configuration of the clickable button is obtained. The details include information relating to the one or more icons used for displaying the clickable button, and hence the one or more icons associated with the clickable button is obtained in step S1004 based on processing of the information relating to the one or more icons.

After the one or more associated icons are identified for the clickable button, step S1005 is performed for confirming if the icons of all the identified clickable icons are identified. If not, a next identified clickable button is selected in step S1006, and steps S1003 and S1004 are repeated for each clickable button until associated icons of all the clickable buttons are identified.

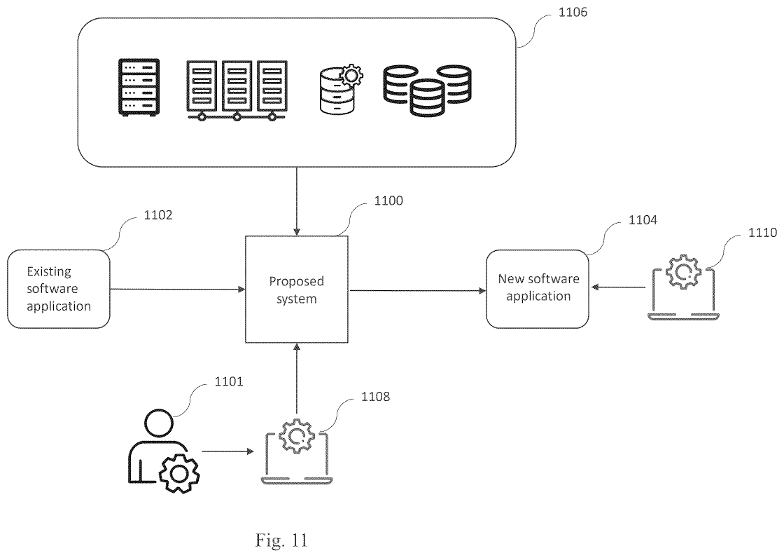

In an embodiment, a new software application can be incorporated with clickable buttons by migration from an existing software application. The existing software application may share the same storage resource for storing of configuration data relating to different functionalities, configuration data of the clickable buttons used, and icons used for displaying clickable buttons. FIG. 11 illustrates an exemplary system for migration of actions from an existing software application to a new software application sharing a common storage resource, in accordance with an embodiment of the present invention. The system 1100 is used for migrating one or more icons of the existing software application 1102 to the new software application 1104, where both the existing software application 1102 and the new software application 1104 share a common storage resource 1106. The storage resource 1106 may be one or more databases, servers, repositories, or any combination thereof.

The one or more clickable buttons to be migrated from the existing software application 1102 to the new software application 1104 may be based on an input provided by an authorized individual 1101 by means of a user device 1108. The one or more clickable buttons are identified based on processing of the input provided by the authorized individual 1101 by the system 1100, and identification of the one or more clickable buttons. The system 1100 thereafter identifies the one or more icons associated with each of the clickable buttons, based on configuration data associated with each clickable button. The configuration data for clickable buttons of the existing software application 1102 is stored in the storage resource 1106, and the configuration data of the one or more clickable buttons to be migrated may be accessed or retrieved from the storage resource 1106.

The configuration data of each clickable button to be migrated may be used by the system 1100 for identifying the one or more icons associated with the clickable button. On identification of the icons associated with the clickable buttons, the system 1100 generates a unique name for each of the clickable buttons based on rules for name generation. The rules may be pre-configured by developers of the new software application 1104, and stored in the storage resource 1106. Alternatively, the rules may also be configured to the system 1100 by the authorized individual 1101 or any other individual such as developers of the new software application 1104 using the user device 1108.

The unique names generated for each of the clickable buttons to be migrated, and the configuration data for each clickable button to be migrated may be stored in a specific location of the storage resource 1106. Further, an icon record generated by the system 1100 comprising unique names of the icons of the clickable buttons to be migrated, the corresponding icon file names, and any other information relating to the icons, may be stored in the storage resource 1106.

During development of the new software application 1104, the developers may choose to migrate a clickable button for enabling a functionality of the new software application 1104. In one embodiment, the configuration of the clickable button to be migrated corresponding to a functionality may be provided by the developer by means of a configuring device 1110. In such an instance, the configuration of the clickable button and the corresponding unique name of the associated icon may be retrieved by the system 1104. Based on the unique name of the associated icon, the system 1100 identifies the file name of the icon based on the icon record.

On identifying the file name of the icon, the system 1100 performs searching based on the identified file name in different locations within the storage resource 1106. On locating the icon file, the system 1100 determined the path file of the icon file with respect to the new software application 1104. The clickable button is incorporated into the framework of the new software application 1104 using the retrieved configuration data of the clickable button, and is thereafter linked with the determined file path. While implementation of the new software application 1104, each clickable button is displayed in the UI of the new software application 1104 by accessing the icon file using the linked file path.

An embodiment of the invention may be an article of manufacture in which a machine-readable medium (such as microelectronic memory) has stored thereon instructions which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components. Also, although the discussion focuses on uplink medium control with respect to frame aggregation, it is contemplated that control of other types of messages are applicable.

In the above description, for purposes of explanation, numerous specific details are set forth in order to provide a thorough understanding of the present systems and methods. It will be apparent the systems and methods may be practiced without these specific details. Reference in the specification to “an example” or similar language means that a particular feature, structure, or characteristic described in connection with that example is included as described, but may not be included in other examples.

An interface may be used to provide input or fetch output from the system. The interface may be implemented as a Command Line Interface (CLI), Graphical User Interface (GUI). Further, Application Programming Interfaces (APIs) may also be used for remotely interacting with edge systems and cloud servers.

A processor may include one or more general purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor), MIPS/ARM-class processor, a microprocessor, a digital signal processor, an application specific integrated circuit, a microcontroller, a state machine, or any type of programmable logic array.

A memory may include, but is no limited to, non-transitory machine-readable storage devices such as hard drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or other type of media/machine-readable medium suitable for storing electronic instructions.

The terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

Any combination of the above features and functionalities may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set as claimed in claims that issue from this application, in the specific form in which such claims issue, including any subsequent correction.

We claim:

1. A method for migration of actions between software applications, the method comprising:
identifying a clickable button to be migrated from a first software application to a second software application;
identifying an icon associated with the clickable button, wherein the icon is stored in a location accessible to the first software application, and the icon includes at least one of an image, an emoji, a graphic symbol, and a text box;
extracting a unique name of the icon, wherein the unique name is independent of the location of the icon in the first software application;
transferring details relating to the clickable button and the unique name of the icon, from the first software application to the second software application;
identifying for the icon, a path in one or more databases accessible to the second software application, based on the unique name of the icon; and
linking the clickable button with the path of the icon, in the second software application.

2. The method of claim 1, further comprising:
rendering the clickable button with the icon on a user interface of the second software application.

3. The method of claim 1, further comprising:
providing a functionality in the second software application based on the details relating to the clickable button transferred from the first software application.

4. The method of claim 1, further comprising:
uploading a set of icons of the first software application to the one or more databases accessible to the second software application.

5. The method of claim 1, wherein the clickable button to be migrated from the first software application to the second software application is identified based on capabilities of the second software application.

6. The method of claim 5, wherein the capabilities of the second software application are known before the migration.

7. The method of claim 1, wherein the details relating to the clickable button includes functionality data.

8. The method of claim 7, wherein the icon associated with the clickable button is identified based on the functionality data associated with the clickable button.

9. The method of claim 7, wherein the unique name for the icon is extracted based on processing of the functionality data associated with the clickable button.

10. The method of claim 1, wherein the path of the icon is identified based on matching of the unique name of the icon to files stored in the one or more databases accessible to the second software application.

11. A system for migration of actions between software applications, the system comprising:
a processor; and
a memory coupled with the processor, wherein the memory stores program instructions configured to:
identify a clickable button to be migrated from a first software application to a second software application;
identify an icon associated with the clickable button, wherein the icon is stored in a location accessible to the first software application, and the icon includes at least one of an image, an emoji, a graphic symbol, and a text box;
extract a unique name of the icon, wherein the unique name is independent of the location of the icon in the first software application;
transfer details relating to the clickable button and the unique name of the icon from the first software application to the second software application;
identify for the icon, a path in one or more databases accessible to the second software application, based on the unique name of the icon; and
link the clickable button with the path of the icon, in the second software application.

12. The system of claim 11, wherein the program instructions are further configured to:
render the clickable button with the icon on a user interface of the second software application.

13. The system of claim 11, wherein the program instructions are further configured to:
provide a functionality in the second software application based on the details relating to the clickable button transferred from the first software application.

14. The system of claim 11, wherein the program instructions are further configured to:
upload a set of icons of the first software application to the one or more databases accessible to the second software application.

15. The system of claim 11, wherein the clickable button to be migrated from the first software application to the second software application is identified based on capabilities of the second software application.

16. The system of claim 15, wherein the capabilities of the second software application are known before the migration.

17. The system of claim 11, wherein the details relating to the clickable button includes functionality data.

18. The system of claim 17, wherein the icon associated with the clickable button is identified based on the functionality data associated with the clickable button, and the unique name for the icon is extracted based on processing of the functionality data associated with the clickable button.

19. The system of claim 11, wherein the path of the icon is identified by a matching of the unique name of the icon to files stored in the one or more databases accessible to the second software application.

20. A non-transitory computer-readable storage medium comprising computer program code for execution by one or more processors of an apparatus, the computer program code configured to, when executed by the one or more processors, cause the apparatus to:
identify a clickable button to be migrated from a first software application to a second software application;
identify an icon associated with the clickable button, wherein the icon is stored in a location accessible to the first software application, and the icon includes at least one of an image, an emoji, a graphic symbol, and a text box;
extract a unique name of the icon, wherein the unique name is independent of the location of the icon in the first software application;
transfer details relating to the clickable button and the unique name of the icon from the first software application to the second software application;
identify for the icon, a path in one or more databases accessible to the second software application, based on the unique name of the icon; and
link the clickable button with the path of the icon, in the second software application.
